(19) United States
(12) Patent Application Publication
(10) Pub. No.: US 2019/0109500 A1
(43) Pub. Date: Apr. 11, 2019

(54) METHOD OF MANUFACTURING STATORE CORE, AND STATOR CORE

(71) Applicant: TOSHIBA INDUSTRIAL PRODUCTS AND SYSTEMS CORP, Kawasaki-Shi (JP)

(72) Inventors: Takayuki AKATSUKA, Mie-gun (JP); Chidai ISAKA, Mie-gun (JP); Toyonobu YAMADA, Mie-gun (JP); Youichi SEO, Mie-gun (JP)

(73) Assignee: TOSHIBA INDUSTRIAL PRODUCTS AND SYSTEMS CORP, KAWASAKI-SHI (JP)

(21) Appl. No.: 16/214,774

(22) Filed: Dec. 10, 2018

Related U.S. Application Data
(63) Continuation of application No. PCT/JP2017/014831, filed on Apr. 11, 2017.

(30) Foreign Application Priority Data
Jun. 10, 2016 (JP) 2016-116487

(51) Int. Cl. H02K 1/18; H02K 15/02

(52) U.S. Cl. CPC H02K 1/18; H02K 15/02

(57) ABSTRACT

According to a method of manufacturing a stator core of an embodiment, welding beads including a magnetic member other than the core pieces are formed in welding grooves provided on an outer peripheral surface of the stacked core pieces and extending in a direction in which the core pieces are stacked.

### CROSS-REFERENCE TO RELATED APPLICATION(S)

This application is a continuation to an International Application No. PCT/JP2017/014831, filed on Apr. 11, 2017 which is based upon and claims the benefit of priority from Japanese Patent Application No. 2016-116487, filed on, Jun. 10, 2016, the entire contents of which are incorporated herein by reference.

### TECHNICAL FIELD

Embodiments of the present invention relate to a method of manufacturing a stator core formed by stacking thin plate shaped core pieces and to a stator core.

### BACKGROUND ART

Conventionally, a stator core formed by stacking thin plate shaped core pieces is known. In such stator cores, the stacked core pieces are secured by welding, swaging, or the like as disclosed for example in patent document 1.

### PRIOR ART DOCUMENT

### Patent Document

Patent Document 1: Japanese Patent Application Publication No. 2011-87386 A

### SUMMARY OF INVENTION

### Problem Solved by Invention

Iron loss is known to increase when the core pieces are formed into a stator core compared to a state in which the core pieces are merely stacked. This is believed to originate from the stress generated at the time of welding or swaging that remain in the stator core.

Thus, there is provided a method of manufacturing a stator core and a stator core capable of suppressing increase of iron loss.

### Solution to Problem

A method of manufacturing a stator core of an embodiment forms a welding bead including a magnetic member other than the core pieces in a welding groove provided on an outer peripheral surface of the stacked core pieces and extending in a direction in which the core pieces are stacked.

A stator core of an embodiment includes a welding groove provided on an outer peripheral surface of the stacked core pieces and extending in a direction in which the core pieces are stacked; and a welding bead including a magnetic member other than the core pieces and being formed in the welding groove to secure the stator core.

### BRIEF DESCRIPTION OF THE DRAWINGS

FIG. 1 schematically illustrates a stator core according to an embodiment.

FIG. 2 is a flowchart of a manufacturing process flow of the stator core.

FIG. 3 schematically illustrates a core piece.

FIG. 4 schematically illustrates block cores and how they are stacked.

FIG. 5 schematically illustrates a welding torch.

FIG. 6 schematically illustrates how welding is performed.

### EMBODIMENTS OF INVENTION

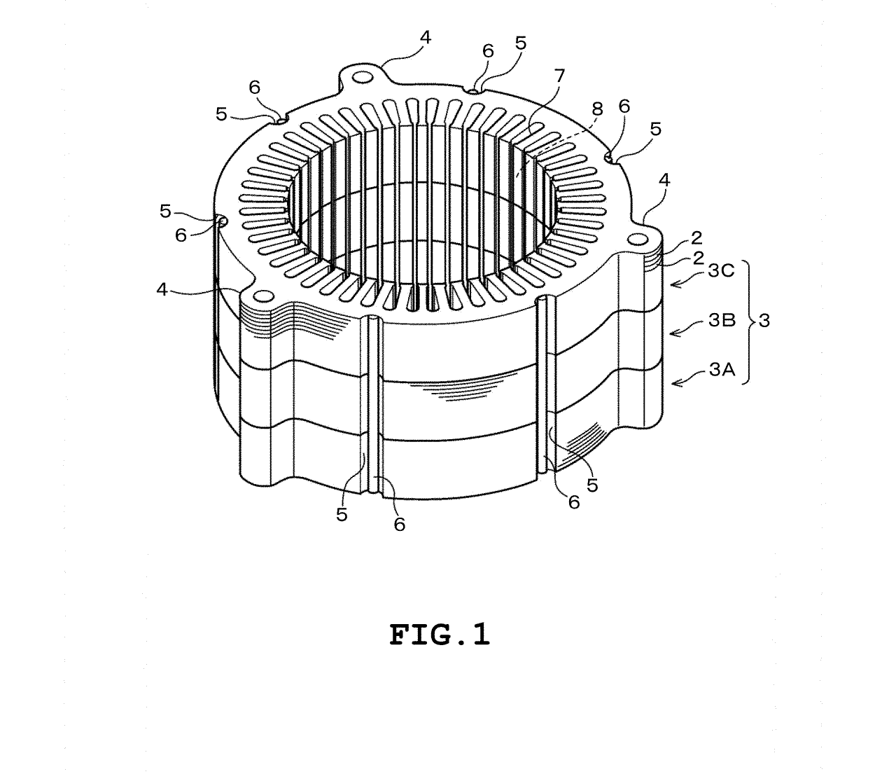

An embodiment will be described hereinafter with reference to FIGS. 1 to 6.

As shown in FIG. 1, a stator core 1 of the present embodiment is formed by stacking thin plate shaped core pieces 2. The core pieces 2 are formed for example by annularly punching an electromagnetic steel plate by a pressing machine as known in the art. The present embodiment envisages the use of a steel plate having relatively high silicon content and being relatively thin to improve high-frequency properties as the electromagnetic steel plate forming the core pieces 2. Further, the surface of the electromagnetic steel plate is covered by an insulation coating as known in the art.

By stacking the core pieces 2 in the thickness direction of the core pieces 2, the stator core 1 is formed into a substantially annular shape with slots 7 for storing windings not shown and a hollow portion 8 for storing a rotor not shown formed in the inner peripheral side thereof. Further, though later described in detail, the stator core 1 of the present embodiment is formed by stacking three core blocks 3A to 3C to absorb the variation in the thickness of the electromagnetic steel plates.

A plurality of mounting portions 4 are provided on the outer peripheral surface of the stator core 1. In the present embodiment, the mounting portions 4 are provided equally at three locations of the outer peripheral surface of the stator core 1 at approximately 120 degree intervals. Further, a plurality of welding grooves 5 extending in the direction in which the core pieces 2 are stacked is provided on the outer peripheral surface of the stator core 1. In the present embodiment, the welding grooves 5 are provided equally at six locations of the outer peripheral surface of the stator core 1 at approximately 60 degree intervals. The above described number of core blocks 3, the number of mounting portions 4, and the number of welding grooves 5 are merely examples and are not to be limited to such numbers.

Welding beads 6 are formed in the welding grooves 5. As later described in detail, the welding beads 6 are formed by welding and secures the core pieces 2, that is, the stator core 1. The stator core 1 is maintained in a predetermined shape, in particular, in a predetermined stacking height by the welding beads 6.

Next, a description will be given on the operation of the above described structure.

As described earlier, iron loss is known to increase when the core pieces 2 are formed into the stator core 1 compared to a state in which the core pieces 2 are merely stacked due to the stress generated at the time of welding or swaging that remain in the stator core 1. Thus, it is strongly desired to suppress the increase of iron loss. A description will be given hereinafter on the stator core 1 capable of suppressing the increase of iron loss and the method of manufacturing the same.

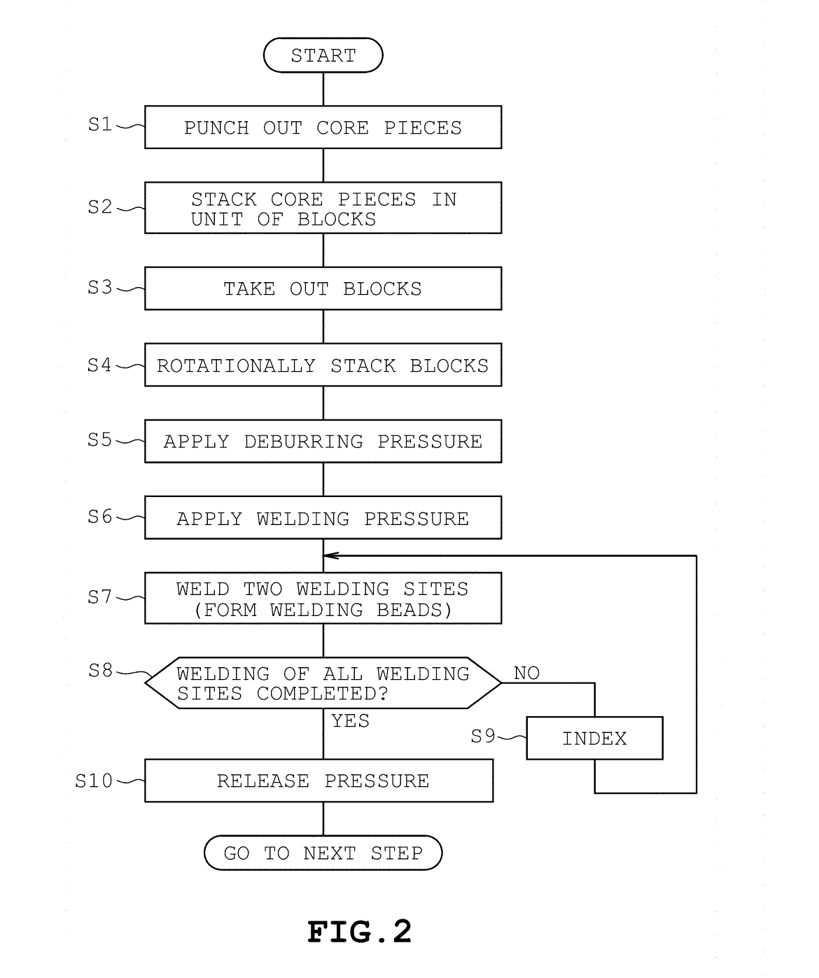

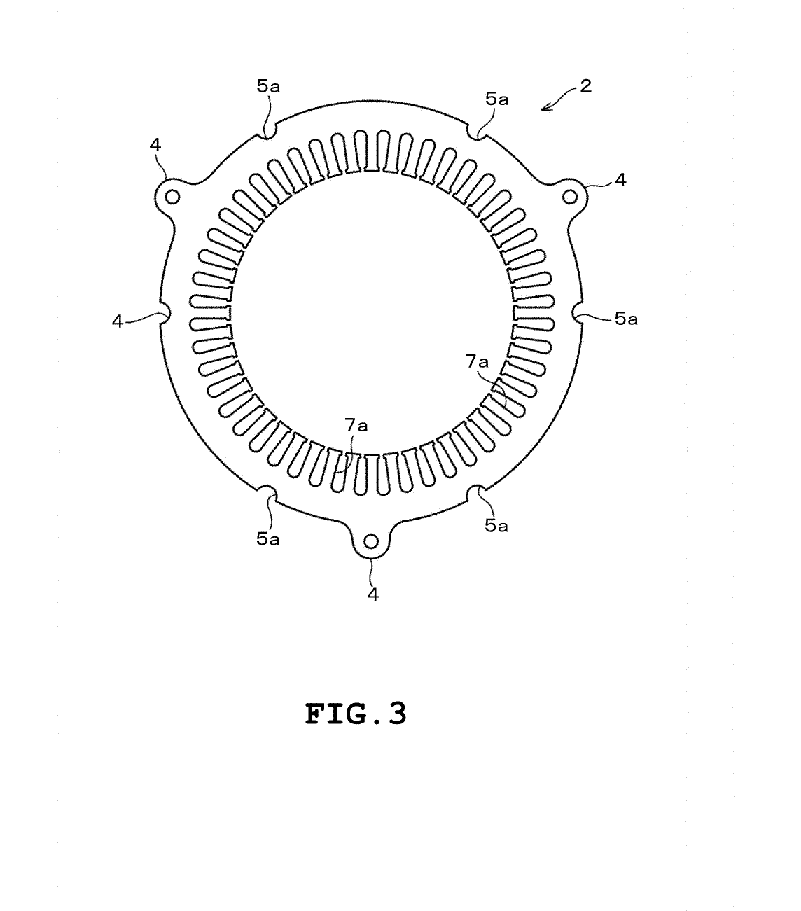

In the manufacturing process flow of the stator core 1, first, the core pieces 2 are punched out (S1) as shown in FIG. 2. In this process step, the electromagnetic steel plates are punched out by a pressing machine to form the core pieces 2. As a result, substantially annular and thin plate shaped core pieces 2 are formed as shown in FIG. 3. In the outer peripheral side of the core pieces 2, mounting portions 4 and recesses 5a that, when the core pieces 2 are stacked, become welding grooves 5 are provided. In the inner peripheral side of the core piece 2, recesses 7a that, when the core pieces 2 are stacked, become slots 7 and the hollow portion 8 that store the rotor not shown are provided.

Next, the core pieces 2 are stacked in the unit of blocks with each block containing a predetermined number of the core pieces 2 (S2). Then, the blocks are taken out (S3), and each of the blocks are rotationally stacked (S4). Though not shown, in the pressing machine, the punched out core pieces 2 fall straight downward and are stacked in the order in which they are punched out. At step S2, at the moment when a predetermined number of core pieces 2 have been punched out, the plurality of punched out core pieces 2 are taken out as a single block, that is, as core blocks 3A to 3C.

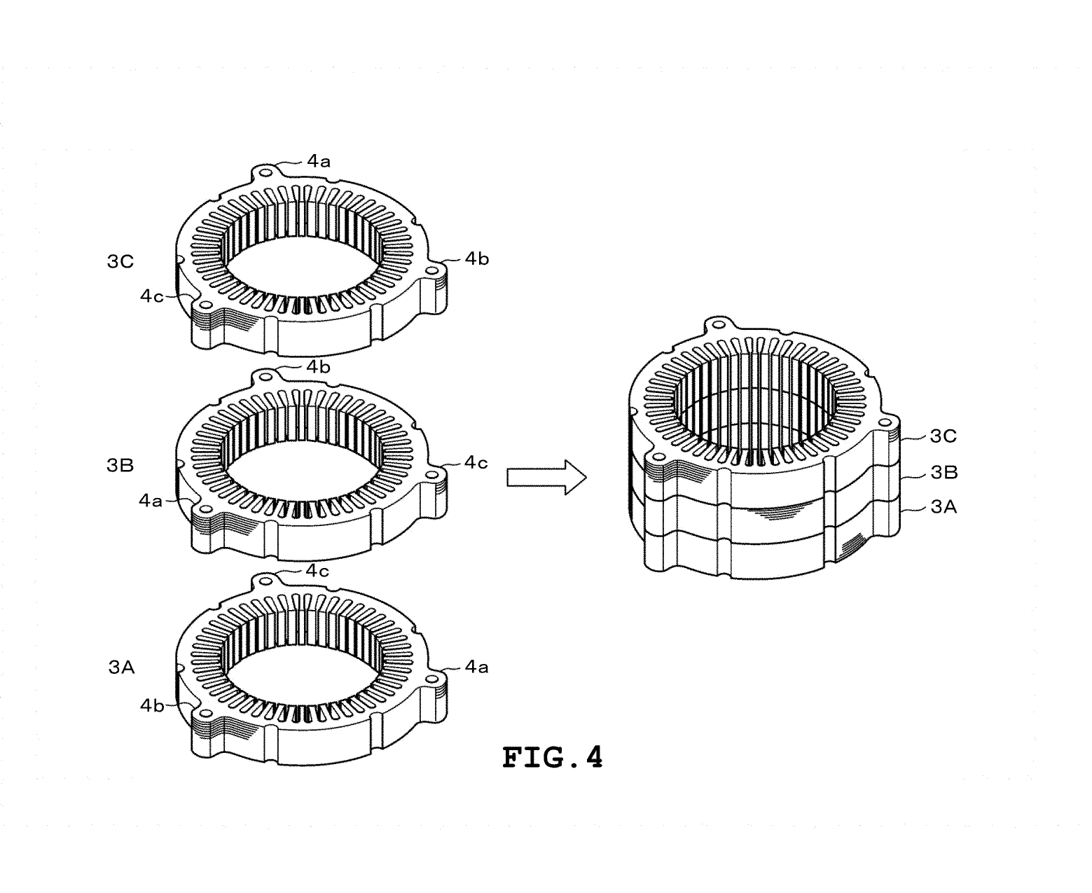

As shown in FIG. 4, the core blocks 3A to 3C which have been taken out each have mounting portions 4a to 4c at three locations in the present embodiment. The mounting portions 4a to 4c are oriented in the same direction when they are punched out from the electromagnetic steel plate. At step S3, the core blocks 3A to 3C are stacked so that, for example, the core block 3B taken out secondly is stacked on the core block 3A taken out firstly after being rotated 120 degrees in the circumferential direction with respect to the core block 3A and the core block 3C taken out thirdly is stacked on the core block 3B after being rotated 120 degrees in the circumferential direction with respect to core block 3B.

Thus, even when there is a variation in the thickness for example of the electromagnetic steel plates of the core pieces 2, the variation can be absorbed by rotationally stacking the core blocks 3A to 3C. In the rotationally stacked state, the stacked height of the core pieces 2 can be made substantially even in the circumferential direction. Though not shown, when rotationally stacking the core blocks 3A to 3C, the core blocks 3A to 3C are stacked in a pressurizing machine provided with a jig to align the centers of the core blocks 3A to 3C so that the core blocks 3A to 3C become concentric.

Next, deburring pressure is applied (S5) to the rotationally stacked core blocks 3A to 3C. Because the core pieces 2 are punched out by the pressing machine as described above, burrs may be formed where the core pieces 2 are cut. Thus, at step S5, relatively strong force is applied in the stacking direction to crush the burrs. As a result, the burrs are crushed so as to planarize each of the core pieces 2.

Next, welding pressure is applied (S6) to the core blocks 3A to 3C which have been deburred with a force smaller than the force applied when deburring pressure was applied. When the above described deburring pressure is applied, relatively strong force is applied in order to crush the burrs, however, the force may deform the core pieces 2 in the thickness direction. When the stator core 1 is formed with such force applied, the force exerted on the core pieces 2 to return to the original shape may remain as stress in the stator core 1 and may increase iron loss.

On the other hand, the height dimension and the density of the steel plates of the formed stator core 1 are set in advance to obtain the desired properties and thus, such settings need to be satisfied. Hence, by setting the force applied for welding to be smaller than the force applied when the deburring pressure was applied, the height dimension, etc. of the formed stator core 1 are satisfied while preventing excessive stress from remaining in the stator core 1.

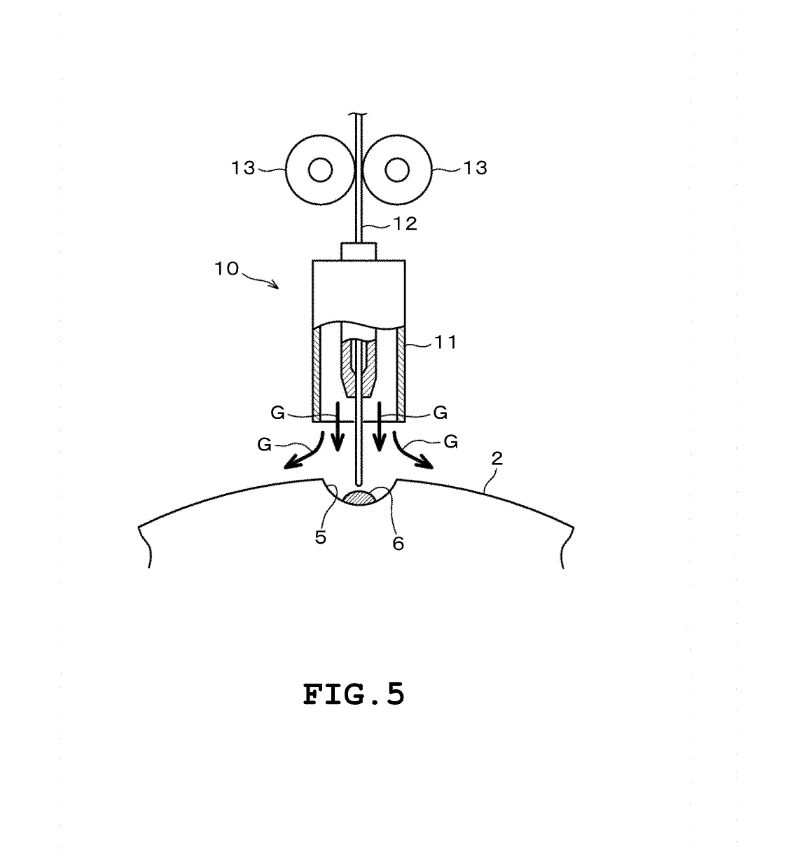

Next, the core pieces 2 are welded. In the present embodiment, a welding torch 10 illustrated in FIG. 5 is used to weld the core pieces 2, that is, to form the welding beads 6. The welding torch 10 is configured so that a magnetic member 12 serving as an electrode material supplied in a wire shape from an external source extends through a main body 11 shaped like a bottomed cylinder having one end thereof opened. The amount of magnetic member 12 required for welding is supplied as required by a rotating reel 13. Further, the welding torch 10 is provided with a gas supplying portion not shown which supplies a shielding gas G into the main body 11 and the shielding gas G is discharged from an opening of the main body 11. The shielding gas G comprises solely of carbon dioxide gas or a mixture of carbon dioxide gas and inert gas.

Thus, the magnetic member 12 melts with the tip side, that is, the core piece 2 side surrounded by the shielding gas G to form the welding beads 6. That is, the welding beads 6 of the present embodiment contain magnetic member 12 other than the core pieces 2, uses the magnetic member 12 supplied in a wire shape from an external source as a primary material, and is formed by melting the magnetic member 12 while covering the magnetic member 12 with the shielding gas G. More simply, the present embodiment welds the core pieces 2, that is, forms the welding beads 6 by the so called MAG (Metal Active Gas) welding or MIG (Metal Inert Gas) welding. During the welding, the welding torch 10 side assumes the positive side and the core piece 2 side assumes the negative side.

Conventionally, TIG (Tungsten Inert Gas) welding was generally used in welding the core pieces 2. In the TIG welding, the base material (the core pieces 2 in this case) itself was melted and thus, there was a large amount of melted base material, a large amount of heat input to the base material, and a large amount of deformation in the state in which the core pieces 2 are stacked (hereinafter referred to as the core for convenience). Thus, there were defects such as a deviation in the squareness of the core caused by the undulating deformation of the end surfaces of the core, increased tendency of the gap between the core and the rotor becoming uneven, deterioration of iron loss due to increased amount of portions affected by heat, and gaps being formed between the core pieces 2 due to thermal deformation caused by large amount of base material melting even when spot welding is employed.

Further, there were factors that lead to poor workability such as requiring cooling time to reduce the temperature of the core to the surrounding temperature since the temperature of the core was increased by welding, requiring replacement of the electrode due to the consumption of the tip of the electrode, requiring the dimension of the blade of the punching mold to be adjusted in advance in anticipation of thermal deformation.

In case of the MIG welding or the MAG welding employed in the present embodiment on the other hand, the amount of melted core pieces 2 is reduced compared to TIG welding since the magnetic member serving as the electrode member is melted. Thus, heat input to the core pieces 2 is reduced compared to TIG welding, thereby reducing the deformation of the core by thermal deformation compared to TIG welding.

Thus, the deviation in the squareness of the core caused by the undulating deformation of the end surfaces of the core, the possibility of the gap between the core and the rotor becoming uneven, and deterioration of iron loss due to the effect of heat, etc. become less compared to TIG welding. Further, factors leading to deterioration of workability can be eliminated since the cooling time to reduce the temperature of the core to the surrounding temperature can be reduced since the core is not increased to high temperatures by the welding, the replacement of the electrode is not required because the electrode is provided externally, and the adjustment of the blade dimension of the punching mold in anticipation of thermal deformation is not required, etc.

Further, since the welding bead 6 does not depend on the properties and the material of the core pieces 2, the present embodiment can be applied to a thin plate shaped core piece 2 of 0.2 mm or less. When the core pieces 2 are thinned, greater number of core pieces 2 need to be stacked to reach the same height and thus, the percentage of insulating material with respect to the steel material relatively increases. Thus, when the base material, that is, the core pieces 2 are melted as in the TIG welding, relatively increased amount of insulating material, that is, impurities are contained in the welding beads 6 and may cause reduction of strength, etc.

In case of the MAG welding or the MIG welding on the other hand, the welding beads 6 are primarily formed of the magnetic member 12 supplied from an external source and thus, is not susceptible to being affected by the increase in the insulating material caused by the thinning of the core pieces 2. As a result, the risk of causing reduction in the strength of the welding beads 6 is reduced to obtain the designed strength.

The present embodiment employs the MAG welding or the MIG welding for welding the core pieces 2 for the above described reasons.

The welding speed of the MAG welding or the MIG welding is approximately 150 cm/min as opposed to the welding speed of a general TIG welding which is approximately 20 cm/min, being 8 to 9 times faster than the TIG welding. This means that when six welding grooves 5 are provided as in the present embodiment for example, the work time can be reduced by 8 to 9 times in case six welding torches are used at the same time as in a general TIG welding and that total work time can be reduced compared to the TIG welding even when only one welding torch is used.

That is, employing the MAG welding or the MIG welding contributes largely not only in preventing the increase of iron loss as described above but also in improving the work efficiency.

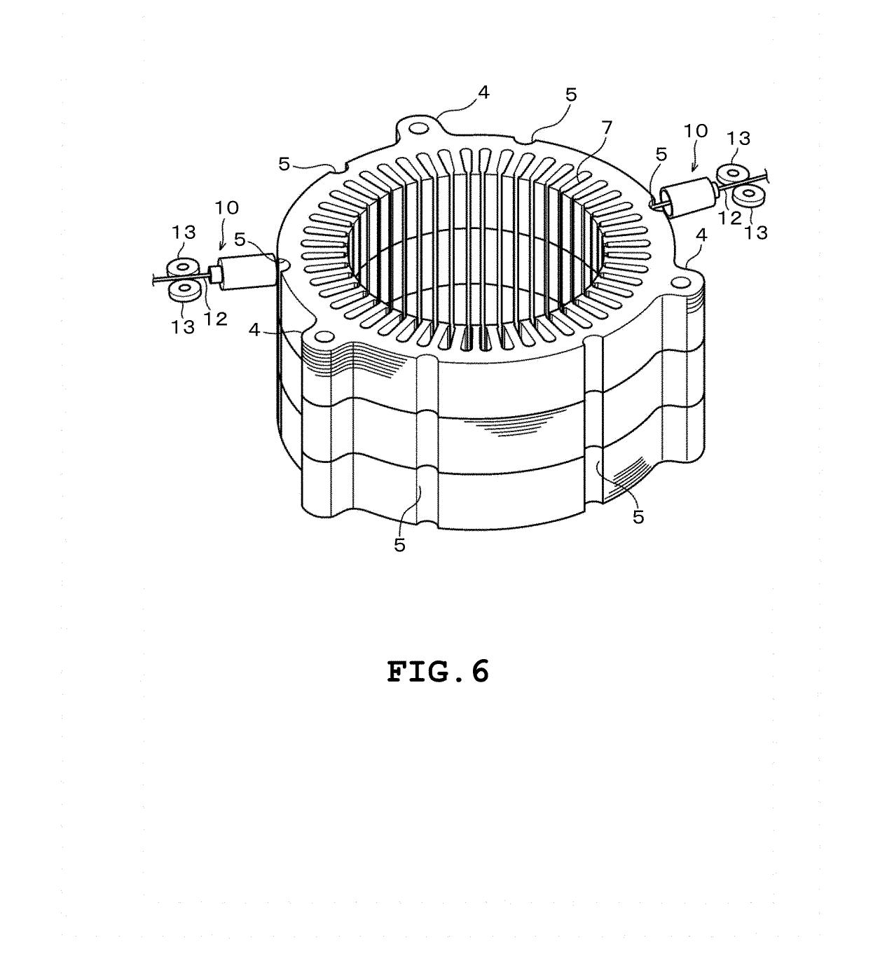

In the present embodiment, two welding torches 10 are used to weld two welding sites simultaneously (S7) as illustrated in FIG. 6 while applying welding pressure, and if not all the welding sites are welded (S8: NO), the core is indexed, that is, rotated circumferentially (S9) and the process thereafter proceeds to step S7 to repeat the welding of unwelded locations. In the present embodiment, the welding torch 10 is controlled by a robot not shown.

In the present embodiment, welding of all the welding sites that is, formation of the welding beads 6 to the six welding grooves 5 can be performed by repeating the simultaneous welding of two locations for three times. In this case, welding time can be shortened compared to the conventional simultaneous welding of six locations by the TIG welding.

Upon completion of welding of all the welding sites (S8: YES), the welding pressure is released (S10) and the process proceeds to the next step.

The stator core 1 is formed through the above described process flow.

The following effects can be obtained by the above described embodiment.

In the manufacturing method of the stator core 1 of the present embodiment, the welding beads 6 containing magnetic member 12 other than the core pieces are formed in the welding grooves 5 extending in the stacking direction in the outer peripheral surface of the stacked core pieces 2. As a result, the melting amount of the core pieces 2 is relatively reduced since the magnetic member 12 serving as the electrode member is melted. That is, the amount of heat input to the core pieces 2 is relatively reduced to also relatively reduce the deformation of the core by thermal deformation.

As a result, it is possible to reduce the deviation in the squareness of the stator core 1 caused by the undulating deformation of the end surfaces of the stator core 1, the possibility of the gap between the core and the rotor becoming uneven, and the deterioration of iron loss due to the effect of heat, etc. It is thus, possible to suppress the increase of iron loss.

Further, factors leading to deterioration of workability can be eliminated since the cooling time to reduce the temperature of the core to the surrounding temperature can be reduced because the core is not increased to high temperatures by welding, the replacement of the electrode is not required because the electrode is provided from an external source, and the adjustment of the blade dimension of the punching mold in anticipation of thermal deformation is not required.

Further, since the welding bead 6 does not depend on the properties and the material of the core pieces 2, the present embodiment can be applied to a thin plate shaped core piece 2 of 0.2 mm or less. When the core pieces 2 are thinned, the percentage of insulating material with respect to the steel material relatively increases and the insulating material is contained as impurities in the welding beads 6 in case when the core pieces 2 are melted as in the TIG welding for example. However, the effect of the increase of insulating material originating from the thinning of the core pieces 2 can be made less by containing magnetic member 12 other than the core pieces 2 in the welding beads 6. Thus, risk of causing reduction in the strength of the welding beads 6, etc. is reduced to obtain the designed strength.

Further, the welding beads 6 are formed by melting the magnetic member 12 while supplying the magnetic member 12 in a wire shape from an external source and covering the magnetic member 12 with the shielding gas G comprising solely of carbon dioxide gas or a mixture of carbon dioxide gas and inert gas. That is, the MAG welding or the MIG welding generally known in the art is used to weld the core pieces 2, that is, to form the welding beads. As a result, it is possible to prevent incorporation of impurities into the welding beads 6, and reduce the amount of heat input into the core pieces 2 as the welding beads 6 can be formed primarily by the magnetic member 12.

The welding beads 6 are formed while applying pressure to the stacked core pieces 2 in the direction in which the core pieces 2 are stacked. It is thus, possible to form the stator core 1 having a predetermined stacking height.

The welding grooves 5 are provided at plural locations of the outer peripheral surface of the stator core 1, the welding beads 6 are formed simultaneously in two or more welding grooves 5, whereafter the stacked core pieces 2 are circumferentially rotated (indexed), and the welding beads 6 are formed in the welding grooves 5 in which the welding beads 6 have not been formed yet. As a result, it is possible to significantly reduce the welding time compared to welding the welding sites one by one and thereby improve the work efficiency.

The stator core 1 of the embodiment is formed in an annular shape by stacking the core pieces 2 in a thin plate shape and is provided with the welding grooves 5 formed on the outer peripheral surface of the core pieces 2 and extending in the stacking direction of the core pieces 2 and the welding beads 6 containing the magnetic member 12 other than the core pieces 2 and formed in the welding grooves 5 to secure the stator core 1. According to such stator core 1, the amount of heat input to the core pieces 2 is relatively reduced and the deformation of the core by thermal deformation is relatively reduced as in the manufacturing method described above. As a result, it is possible to reduce the deviation in the squareness of the core caused by the undulating deformation of the end surfaces of the core, the possibility of the gap between the core and the rotor becoming uneven, and deterioration of iron loss, etc. due to the effect of heat and thereby suppress the increase of iron loss.

### Other Embodiments

The present invention is not limited to the embodiments described above but may modify or combine the configurations and structures described in the embodiments within the gist of the invention.

An embodiment was described through an example in which two welding sites were welded at the same time, however, the welding sites may be welded one by one using a single welding torch 10. Alternatively, three or six welding torches may be provided.

An embodiment was described through an example in which the core pieces 2 were stacked in the unit of blocks but the present invention may be applied to a stack of unbound individual core pieces 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A method of manufacturing a stator core formed annularly by stacking thin plate shaped core pieces comprising:
forming a welding bead including a magnetic member other than the core pieces in a welding groove provided on an outer peripheral surface of the stacked core pieces and extending in a direction in which the core pieces are stacked.

2. The method of manufacturing the stator core according to claim 1, wherein while supplying the magnetic member from an external source, the welding bead is formed by melting the magnetic member while covering the magnetic member with a shielding gas comprising solely of a carbon dioxide gas or a mixture of the carbon dioxide gas and an inert gas.

3. The method of manufacturing the stator core according to claim 1, wherein the welding bead is formed while applying pressure on the stacked core pieces in the direction in which the core pieces are stacked.

4. The method of manufacturing the stator core according to claim 2, wherein the welding bead is formed while applying pressure on the stacked core pieces in the direction in which the core pieces are stacked.

5. The method of manufacturing the stator core according to claim 1, wherein the stator core comprises a plurality of the welding grooves provided at plurality of locations in the outer peripheral surface of the stacked core pieces, and wherein the stator core comprises a plurality of the welding beads formed simultaneously in the welding grooves in two or more locations, whereafter the stacked core pieces are rotated in the circumferential direction and the welding beads are formed in the welding grooves where the welding beads have not been formed yet.

6. The method of manufacturing the stator core according to claim 2, wherein the stator core comprises a plurality of the welding grooves provided at plurality of locations in the outer peripheral surface of the stacked core pieces, and wherein the stator core comprises a plurality of the welding beads formed simultaneously in the welding grooves in two or more locations, whereafter the stacked core pieces are rotated in the circumferential direction and the welding beads are formed in the welding grooves where the welding beads have not been formed yet.

7. The method of manufacturing the stator core according to claim 3, wherein the stator core comprises a plurality of the welding grooves provided at plurality of locations in the outer peripheral surface of the stacked core pieces, and wherein the stator core comprises a plurality of the welding beads formed simultaneously in the welding grooves in two or more locations, whereafter the stacked core pieces are rotated in the circumferential direction and the welding beads are formed in the welding grooves where the welding beads have not been formed yet.

8. The method of manufacturing the stator core according to claim 4, wherein the stator core comprises a plurality of the welding grooves provided at plurality of locations in the outer peripheral surface of the stacked core pieces, and wherein the stator core comprises a plurality of the welding beads formed simultaneously in the welding grooves in two or more locations, whereafter the stacked core pieces are rotated in the circumferential direction and the welding beads are formed in the welding grooves where the welding beads have not been formed yet.

9. A stator core formed annularly by stacking thin plate shaped core pieces comprising:
a welding groove provided on an outer peripheral surface of the stacked core pieces and extending in a direction in which the core pieces are stacked; and
a welding bead including a magnetic member other than the core pieces and being formed in the welding groove to secure the stator core.
